(19) United States
(12) Patent Application Publication
(10) Pub. No.: US 2008/0001977 A1
(43) Pub. Date: Jan. 3, 2008

(54) Generating and displaying spatially offset sub-frames

(76) Inventors: Richard E. Aufranc, Corvallis, OR (US); Stan E. Leigh, Corvallis, OR (US); Arnold W. Larson, Corvallis, OR (US); William J. Allen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/480,101

(22) Filed: Jun. 30, 2006

(51) Int. Cl. G09G 5/02

(52) U.S. Cl. 345/698

(57) ABSTRACT

A method of displaying an image with a display device includes receiving image data for the image. A first plurality of sub-frames corresponding to the image data is generated based on a first plurality of spatially offset sub-frame positions. A second plurality of sub-frames is generated based on the first plurality of sub-frames and based on a second plurality of spatially offset sub-frame positions. The second plurality of sub-frames is displayed at the second plurality of spatially offset sub-frame positions.

### CROSS-REFERENCE TO RELATED APPLICATIONS

This application is related to U.S. patent application Ser. No. 10/213,555, filed on Aug. 7, 2002, entitled IMAGE DISPLAY SYSTEM AND METHOD; U.S. patent application Ser. No. 10/242,195, filed on Sep. 11, 2002, entitled IMAGE DISPLAY SYSTEM AND METHOD; U.S. patent application Ser. No. 10/242,545, filed on Sep. 11, 2002, entitled IMAGE DISPLAY SYSTEM AND METHOD; U.S. patent application Ser. No. 10/631,681, filed Jul. 31, 2003, entitled GENERATING AND DISPLAYING SPATIALLY OFFSET SUB-FRAMES; U.S. patent application Ser. No. 10/632,042, filed Jul. 31, 2003, entitled GENERATING AND DISPLAYING SPATIALLY OFFSET SUB-FRAMES; U.S. patent application Ser. No. 10/672,845, filed Sep. 26, 2003, entitled GENERATING AND DISPLAYING SPATIALLY OFFSET SUB-FRAMES; U.S. patent application Ser. No. 10/672,544, filed Sep. 26, 2003, entitled GENERATING AND DISPLAYING SPATIALLY OFFSET SUB-FRAMES; U.S. patent application Ser. No. 10/697,605, filed Oct. 30, 2003, entitled GENERATING AND DISPLAYING SPATIALLY OFFSET SUB-FRAMES ON A DIAMOND GRID; U.S. patent application Ser. No. 10/696,888, filed Oct. 30, 2003, entitled GENERATING AND DISPLAYING SPATIALLY OFFSET SUB-FRAMES ON DIFFERENT TYPES OF GRIDS; U.S. patent application Ser. No. 10/697,830, filed Oct. 30, 2003, entitled IMAGE DISPLAY SYSTEM AND METHOD; U.S. patent application Ser. No. 10/750,591, filed Dec. 31, 2003, entitled DISPLAYING SPATIALLY OFFSET SUB-FRAMES WITH A DISPLAY DEVICE HAVING A SET OF DEFECTIVE DISPLAY PIXELS; U.S. patent application Ser. No. 10/768,621, filed Jan. 30, 2004, entitled GENERATING AND DISPLAYING SPATIALLY OFFSET SUB-FRAMES; U.S. patent application Ser. No. 10/768,215, filed Jan. 30, 2004, entitled DISPLAYING SUB-FRAMES AT SPATIALLY OFFSET POSITIONS ON A CIRCLE; U.S. patent application Ser. No. 10/821,135, filed Apr. 8, 2004, entitled GENERATING AND DISPLAYING SPATIALLY OFFSET SUB-FRAMES; U.S. patent application Ser. No. 10/821,130, filed Apr. 8, 2004, entitled GENERATING AND DISPLAYING SPATIALLY OFFSET SUB-FRAMES; U.S. patent application Ser. No. 10/820,952, filed Apr. 8, 2004, entitled GENERATING AND DISPLAYING SPATIALLY OFFSET SUB-FRAMES; U.S. patent application Ser. No. 10/864,125, Docket No. 200401412-1, filed Jun. 9, 2004, entitled GENERATING AND DISPLAYING SPATIALLY OFFSET SUB-FRAMES; U.S. patent application Ser. No. 10/868,719, filed Jun. 15, 2004, entitled GENERATING AND DISPLAYING SPATIALLY OFFSET SUB-FRAMES, U.S. patent application Ser. No. 10/868,638, filed Jun. 15, 2004, entitled GENERATING AND DISPLAYING SPATIALLY OFFSET SUB-FRAMES; U.S. patent application Ser. No. 11/072,045, filed Mar. 4, 2005, entitled GENERATING AND DISPLAYING SPATIALLY OFFSET SUB-FRAMES; and U.S. patent application Ser. No. 11/221,271, filed Sep. 7, 2005, entitled GENERATING AND DISPLAYING SPATIALLY OFFSET SUB-FRAMES. Each of the above U.S. patent applications is assigned to the assignee of the present invention, and is hereby incorporated by reference herein.

### BACKGROUND

A conventional system or device for displaying an image, such as a display, projector, or other imaging system, produces a displayed image by addressing an array of individual picture elements or pixels arranged in horizontal rows and vertical columns. A resolution of the displayed image is defined as the number of horizontal rows and vertical columns of individual pixels forming the displayed image. The resolution of the displayed image is affected by a resolution of the display device itself as well as a resolution of the image data processed by the display device and used to produce the displayed image.

Typically, to increase a resolution of the displayed image, the resolution of the display device as well as the resolution of the image data used to produce the displayed image needs to be increased. Increasing the resolution of the display device, however, increases cost and complexity of the display device.

### SUMMARY

One form of the present invention provides a method of displaying an image with a display device. The method includes receiving image data for the image. A first plurality of sub-frames corresponding to the image data is generated based on a first plurality of spatially offset sub-frame positions. A second plurality of sub-frames is generated based on the first plurality of sub-frames and based on a second plurality of spatially offset sub-frame positions. The second plurality of sub-frames is displayed at the second plurality of spatially offset sub-frame positions.

### BRIEF DESCRIPTION OF THE DRAWINGS

FIG. 1 is a block diagram illustrating an image display system according to one embodiment of the present invention.

FIGS. 2A-2C are schematic diagrams illustrating the display of two sub-frames according to one embodiment of the present invention.

FIGS. 3A-3E are schematic diagrams illustrating the display of four sub-frames according to one embodiment of the present invention.

FIGS. 4A-4E are schematic diagrams illustrating the display of a pixel with an image display system according to one embodiment of the present invention.

FIG. 5 is a diagram illustrating the generation of low resolution sub-frames from an original high resolution image using a nearest neighbor algorithm according to one embodiment of the present invention.

FIG. 6 is a diagram illustrating the generation of low resolution sub-frames from an original high resolution image using a bilinear algorithm according to one embodiment of the present invention.

FIG. 7 is a diagram illustrating the generation of actual pixel values for sub-frames based on previously calculated boundary pixel values according to one embodiment of the present invention.

FIG. 8 is a diagram illustrating a plurality of sub-frames shifted along a circle according to one embodiment of the present invention.

FIG. 9 is a flow diagram illustrating the generation of actual pixel values for sub-frames based on previously calculated boundary pixel values according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

### I. Spatial and Temporal Shifting of Sub-Frames

Some display systems, such as some digital light projectors, may not have sufficient resolution to display some high resolution images. Such systems can be configured to give the appearance to the human eye of higher resolution images by displaying spatially and temporally shifted lower resolution images. The lower resolution images are referred to as sub-frames. A problem of sub-frame generation, which is addressed by embodiments of the present invention, is to determine appropriate values for the sub-frames so that the displayed sub-frames are close in appearance to how the high-resolution image from which the sub-frames were derived would appear if directly displayed.

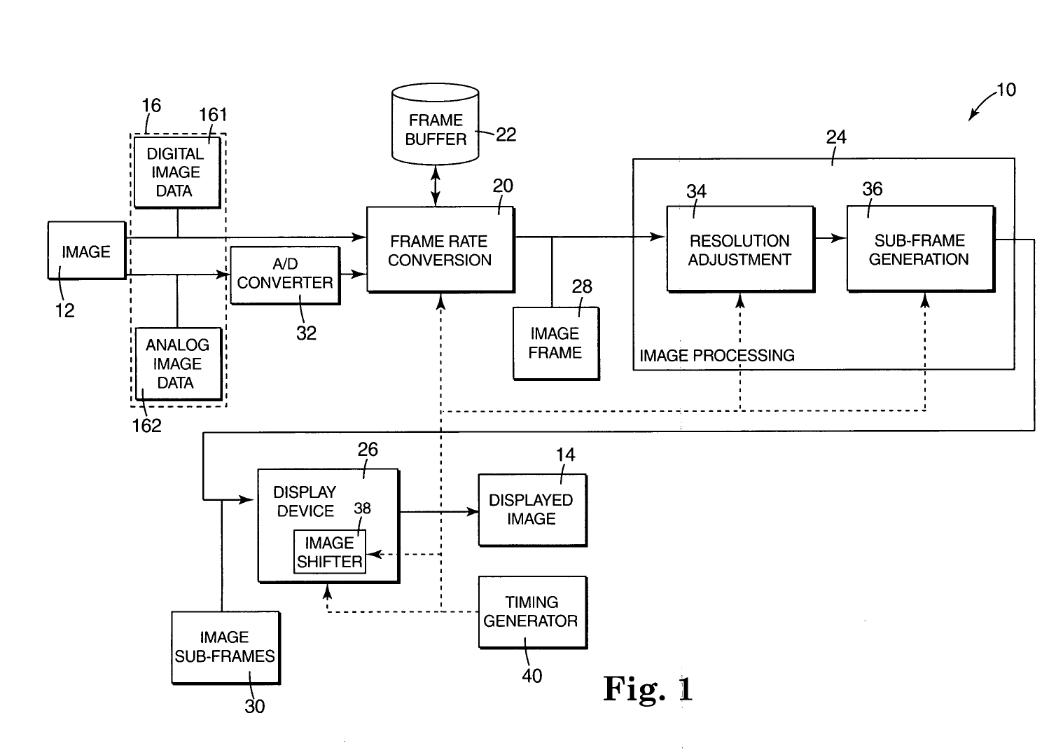

One embodiment of a display system that provides the appearance of enhanced resolution through temporal and spatial shifting of sub-frames is described in the U.S. patent applications cited above, and is summarized below with reference to FIGS. 1-4E.

FIG. 1 is a block diagram illustrating an image display system 10 according to one embodiment of the present invention. Image display system 10 facilitates processing of an image 12 to create a displayed image 14. Image 12 is defined to include any pictorial, graphical, and/or textural characters, symbols, illustrations, and/or other representation of information. Image 12 is represented, for example, by image data 16. Image data 16 includes individual picture elements or pixels of image 12. While one image is illustrated and described as being processed by image display system 10, it is understood that a plurality or series of images may be processed and displayed by image display system 10.

In one embodiment, image display system 10 includes a frame rate conversion unit 20 and an image frame buffer 22, an image processing unit 24, and a display device 26. As described below, frame rate conversion unit 20 and image frame buffer 22 receive and buffer image data 16 for image 12 to create an image frame 28 for image 12. Image processing unit 24 processes image frame 28 to define one or more image sub-frames 30 for image frame 28, and display device 26 temporally and spatially displays image sub-frames 30 to produce displayed image 14.

Image display system 10, including frame rate conversion unit 20 and/or image processing unit 24, includes hardware, software, firmware, or a combination of these. In one embodiment, one or more components of image display system 10, including frame rate conversion unit 20 and/or image processing unit 24, are included in a computer, computer server, or other microprocessor-based system capable of performing a sequence of logic operations. In addition, processing can be distributed throughout the system with individual portions being implemented in separate system components.

Image data 16 may include digital image data 161 or analog image data 162. To process analog image data 162, image display system 10 includes an analog-to-digital (A/D) converter 32. As such, A/D converter 32 converts analog image data 162 to digital form for subsequent processing. Thus, image display system 10 may receive and process digital image data 161 and/or analog image data 162 for image 12.

Frame rate conversion unit 20 receives image data 16 for image 12 and buffers or stores image data 16 in image frame buffer 22. More specifically, frame rate conversion unit 20 receives image data 16 representing individual lines or fields of image 12 and buffers image data 16 in image frame buffer 22 to create image frame 28 for image 12. Image frame buffer 22 buffers image data 16 by receiving and storing all of the image data for image frame 28, and frame rate conversion unit 20 creates image frame 28 by subsequently retrieving or extracting all of the image data for image frame 28 from image frame buffer 22. As such, image frame 28 is defined to include a plurality of individual lines or fields of image data 16 representing an entirety of image 12. Thus, image frame 28 includes a plurality of columns and a plurality of rows of individual pixels representing image 12.

Frame rate conversion unit 20 and image frame buffer 22 can receive and process image data 16 as progressive image data and/or interlaced image data. With progressive image data, frame rate conversion unit 20 and image frame buffer 22 receive and store sequential fields of image data 16 for image 12. Thus, frame rate conversion unit 20 creates image frame 28 by retrieving the sequential fields of image data 16 for image 12. With interlaced image data, frame rate conversion unit 20 and image frame buffer 22 receive and store odd fields and even fields of image data 16 for image 12. For example, all of the odd fields of image data 16 are received and stored and all of the even fields of image data 16 are received and stored. As such, frame rate conversion unit 20 de-interlaces image data 16 and creates image frame 28 by retrieving the odd and even fields of image data 16 for image 12.

Image frame buffer 22 includes memory for storing image data 16 for one or more image frames 28 of respective images 12. Thus, image frame buffer 22 constitutes a database of one or more image frames 28. Examples of image frame buffer 22 include non-volatile memory (e.g., a hard disk drive or other persistent storage device) and may include volatile memory (e.g., random access memory (RAM)).

By receiving image data 16 at frame rate conversion unit 20 and buffering image data 16 with image frame buffer 22, input timing of image data 16 can be decoupled from a timing requirement of display device 26. More specifically, since image data 16 for image frame 28 is received and stored by image frame buffer 22, image data 16 can be received as input at any rate. As such, the frame rate of image frame 28 can be converted to the timing requirement of display device 26. Thus, image data 16 for image frame 28 can be extracted from image frame buffer 22 at a frame rate of display device 26.

In one embodiment, image processing unit 24 includes a resolution adjustment unit 34 and a sub-frame generation unit 36. As described below, resolution adjustment unit 34 receives image data 16 for image frame 28 and adjusts a resolution of image data 16 for display on display device 26, and sub-frame generation unit 36 generates a plurality of image sub-frames 30 for image frame 28. More specifically, image processing unit 24 receives image data 16 for image frame 28 at an original resolution and processes image data 16 to increase, decrease, and/or leave unaltered the resolution of image data 16. Accordingly, with image processing unit 24, image display system 10 can receive and display image data 16 of varying resolutions.

Sub-frame generation unit 36 receives and processes image data 16 for image frame 28 to define a plurality of image sub-frames 30 for image frame 28. If resolution adjustment unit 34 has adjusted the resolution of image data 16, sub-frame generation unit 36 receives image data 16 at the adjusted resolution. The adjusted resolution of image data 16 may be increased, decreased, or the same as the original resolution of image data 16 for image frame 28. Sub-frame generation unit 36 generates image sub-frames 30 with a resolution which matches the resolution of display device 26. Image sub-frames 30 are each of an area equal to image frame 28. Sub-frames 30 each include a plurality of columns and a plurality of rows of individual pixels representing a subset of image data 16 of image 12, and have a resolution that matches the resolution of display device 26.

Each image sub-frame 30 includes a matrix or array of pixels for image frame 28. Image sub-frames 30 are spatially offset from each other such that each image sub-frame 30 includes different pixels and/or portions of pixels. As such, image sub-frames 30 are offset from each other by a vertical distance and/or a horizontal distance, as described below.

Display device 26 receives image sub-frames 30 from image processing unit 24 and sequentially displays image sub-frames 30 to create displayed image 14. More specifically, as image sub-frames 30 are spatially offset from each other, display device 26 displays image sub-frames 30 in different positions according to the spatial offset of image sub-frames 30, as described below. As such, display device 26 alternates between displaying image sub-frames 30 for image frame 28 to create displayed image 14. Accordingly, display device 26 displays an entire sub-frame 30 for image frame 28 at one time.

In one embodiment, display device 26 performs one cycle of displaying image sub-frames 30 for each image frame 28. Display device 26 displays image sub-frames 30 so as to be spatially and temporally offset from each other. In one embodiment, display device 26 optically steers image sub-frames 30 to create displayed image 14. As such, individual pixels of display device 26 are addressed to multiple locations.

In one embodiment, display device 26 includes an image shifter 38. Image shifter 38 spatially alters or offsets the position of image sub-frames 30 as displayed by display device 26. More specifically, image shifter 38 varies the position of display of image sub-frames 30, as described below, to produce displayed image 14.

In one embodiment, display device 26 includes a light modulator for modulation of incident light. The light modulator includes, for example, a plurality of micro-mirror devices arranged to form an array of micro-mirror devices. As such, each micro-mirror device constitutes one cell or pixel of display device 26. Display device 26 may form part of a display, projector, or other imaging system.

In one embodiment, image display system 10 includes a timing generator 40. Timing generator 40 communicates, for example, with frame rate conversion unit 20, image processing unit 24, including resolution adjustment unit 34 and sub-frame generation unit 36, and display device 26, including image shifter 38. As such, timing generator 40 synchronizes buffering and conversion of image data 16 to create image frame 28, processing of image frame 28 to adjust the resolution of image data 16 and generate image sub-frames 30, and positioning and displaying of image sub-frames 30 to produce displayed image 14. Accordingly, timing generator 40 controls timing of image display system 10 such that entire sub-frames 30 of image 12 are temporally and spatially displayed by display device 26 as displayed image 14.

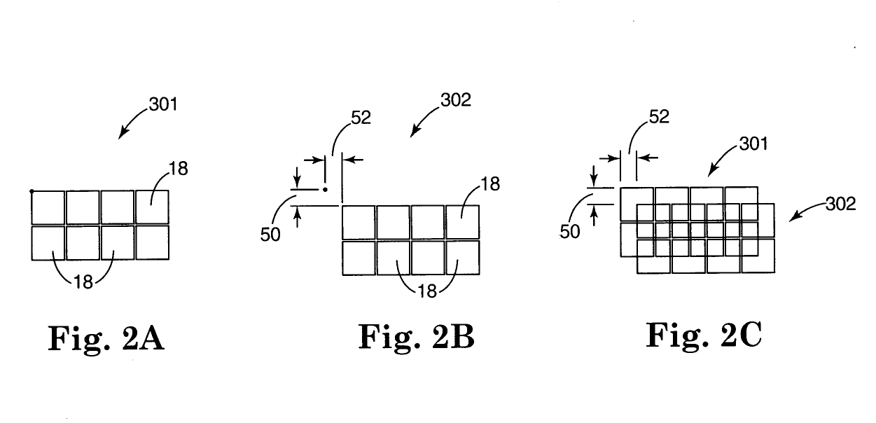

In one embodiment, as illustrated in FIGS. 2A and 2B, image processing unit 24 defines two image sub-frames 30 for image frame 28. More specifically, image processing unit 24 defines a first sub-frame 301 and a second sub-frame 302 for image frame 28. As such, first sub-frame 301 and second sub-frame 302 each include a plurality of columns and a plurality of rows of individual pixels 18 of image data 16. Thus, first sub-frame 301 and second sub-frame 302 each constitute an image data array or pixel matrix of a subset of image data 16.

In one embodiment, as illustrated in FIG. 2B, second sub-frame 302 is offset from first sub-frame 301 by a vertical distance 50 and a horizontal distance 52. As such, second sub-frame 302 is spatially offset from first sub-frame 301 by a predetermined distance. In one illustrative embodiment, vertical distance 50 and horizontal distance 52 are each approximately one-half of one pixel.

As illustrated in FIG. 2C, display device 26 alternates between displaying first sub-frame 301 in a first position and displaying second sub-frame 302 in a second position spatially offset from the first position. More specifically, display device 26 shifts display of second sub-frame 302 relative to display of first sub-frame 301 by vertical distance 50 and horizontal distance 52. As such, pixels of first sub-frame 301 overlap pixels of second sub-frame 302. In one embodiment, display device 26 performs one cycle of displaying first sub-frame 301 in the first position and displaying second sub-frame 302 in the second position for image frame 28. Thus, second sub-frame 302 is spatially and temporally displaced relative to first sub-frame 301. The display of two temporally and spatially shifted sub-frames in this manner is referred to herein as two-position processing. In other embodiments, sub-frames 301 and 302 are spatially displaced using other vertical and/or horizontal distances (e.g., using only vertical displacements or only horizontal displacements).

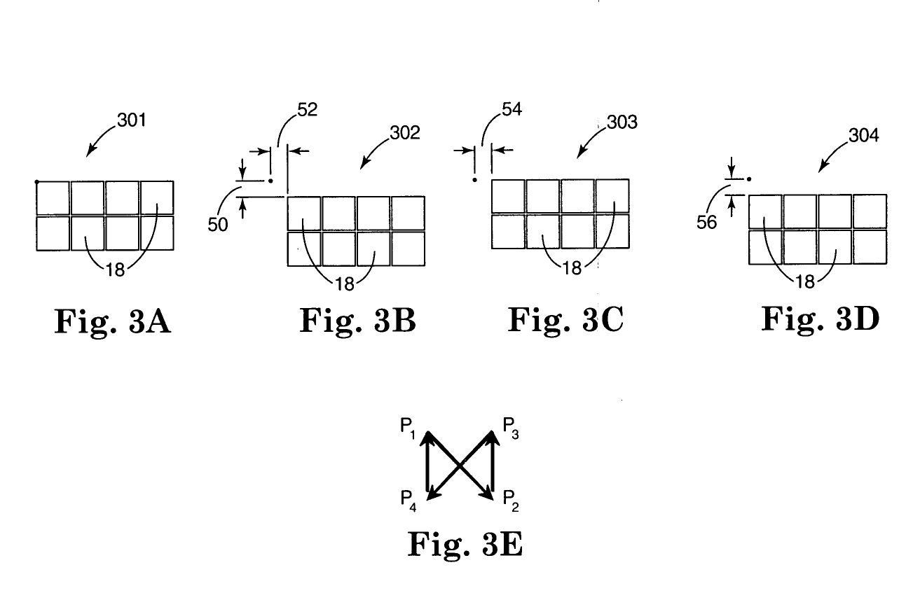

In another embodiment, as illustrated in FIGS. 3A-3D, image processing unit 24 defines four image sub-frames 30 for image frame 28. More specifically, image processing unit 24 defines a first sub-frame 301, a second sub-frame 302, a third sub-frame 303, and a fourth sub-frame 304 for image frame 28. As such, first sub-frame 301, second sub-frame 302, third sub-frame 303, and fourth sub-frame 304 each include a plurality of columns and a plurality of rows of individual pixels 18 of image data 16.

In one embodiment, as illustrated in FIGS. 3B-3D, second sub-frame 302 is offset from first sub-frame 301 by a vertical distance 50 and a horizontal distance 52, third sub-frame 303 is offset from first sub-frame 301 by a horizontal distance 54, and fourth sub-frame 304 is offset from first sub-frame 301 by a vertical distance 56. As such, second sub-frame 302, third sub-frame 303, and fourth sub-frame 304 are each spatially offset from each other and spatially offset from first sub-frame 301 by a predetermined distance. In one illustrative embodiment, vertical distance 50, horizontal distance 52, horizontal distance 54, and vertical distance 56 are each approximately one-half of one pixel.

As illustrated schematically in FIG. 3E, display device 26 alternates between displaying first sub-frame 301 in a first position P₁, displaying second sub-frame 302 in a second position P₂ spatially offset from the first position, displaying third sub-frame 303 in a third position P₃ spatially offset from the first position, and displaying fourth sub-frame 304 in a fourth position P₄ spatially offset from the first position. More specifically, display device 26 shifts display of second sub-frame 302, third sub-frame 303, and fourth sub-frame 304 relative to first sub-frame 301 by the respective predetermined distance. As such, pixels of first sub-frame 301, second sub-frame 302, third sub-frame 303, and fourth sub-frame 304 overlap each other.

In one embodiment, display device 26 performs one cycle of displaying first sub-frame 301 in the first position, displaying second sub-frame 302 in the second position, displaying third sub-frame 303 in the third position, and displaying fourth sub-frame 304 in the fourth position for image frame 28. Thus, second sub-frame 302, third sub-frame 303, and fourth sub-frame 304 are spatially and temporally displayed relative to each other and relative to first sub-frame 301. The display of four temporally and spatially shifted sub-frames in this manner is referred to herein as four-position processing.

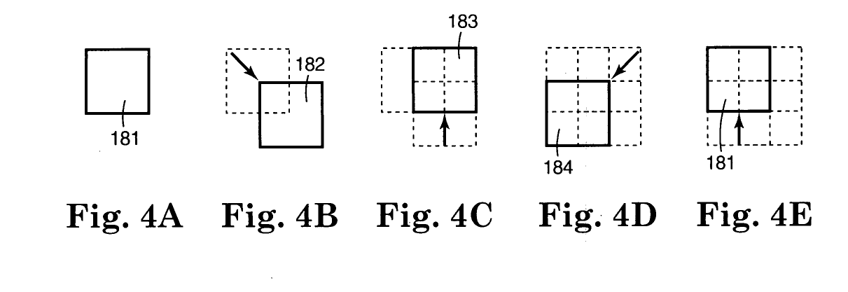

FIGS. 4A-4E illustrate one embodiment of completing one cycle of displaying a pixel 181 from first sub-frame 301 in the first position, displaying a pixel 182 from second sub-frame 302 in the second position, displaying a pixel 183 from third sub-frame 303 in the third position, and displaying a pixel 184 from fourth sub-frame 304 in the fourth position. More specifically, FIG. 4A illustrates display of pixel 181 from first sub-frame 301 in the first position, FIG. 4B illustrates display of pixel 182 from second sub-frame 302 in the second position (with the first position being illustrated by dashed lines), FIG. 4C illustrates display of pixel 183 from third sub-frame 303 in the third position (with the first position and the second position being illustrated by dashed lines), FIG. 4D illustrates display of pixel 184 from fourth sub-frame 304 in the fourth position (with the first position, the second position, and the third position being illustrated by dashed lines), and FIG. 4E illustrates display of pixel 181 from first sub-frame 301 in the first position (with the second position, the third position, and the fourth position being illustrated by dashed lines).

Sub-frame generation unit 36 (FIG. 1) generates sub-frames 30 based on image data in image frame 28. It will be understood by a person of ordinary skill in the art that functions performed by sub-frame generation unit 36 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

In one form of the invention, sub-frames 30 have a lower resolution than image frame 28. Thus, sub-frames 30 are also referred to herein as low resolution images 30, and image frame 28 is also referred to herein as a high resolution image 28. It will be understood by persons of ordinary skill in the art that the terms low resolution and high resolution are used herein in a comparative fashion, and are not limited to any particular minimum or maximum number of pixels.

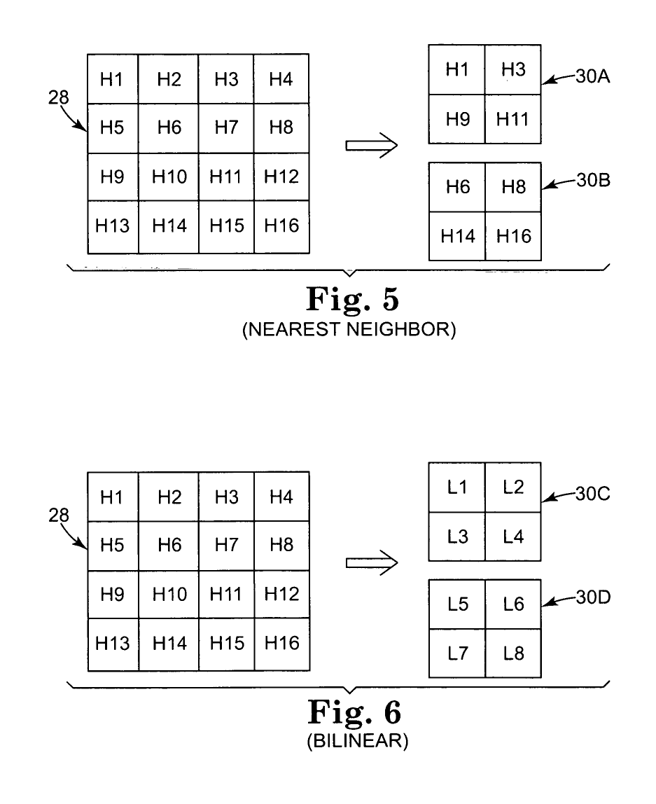

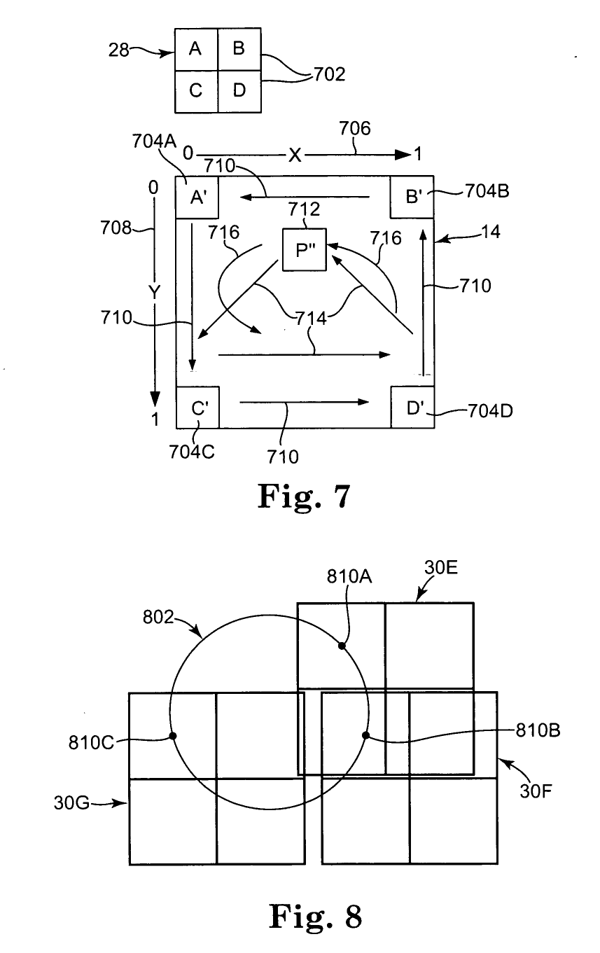

Sub-frame generation unit 36 is configured to use any suitable algorithm to calculate initial or boundary pixel values for sub-frames 30. Sub-frame generation unit 36 then uses the boundary pixel values to generate actual pixel values for the sub-frames 30, as described in further detail below with reference to FIGS. 7-9. In one embodiment, sub-frame generation unit 36 is configured to generate boundary pixel values for sub-frames 30 based on a nearest neighbor algorithm or a bilinear algorithm. The nearest neighbor algorithm and the bilinear algorithm according to one form of the invention generate boundary pixel values for sub-frames 30 by combining pixels from a high resolution image 28, as described in further detail below with reference to FIGS. 5 and 6. In another embodiment, the initial or boundary pixel values for sub-frames 30 are generated based on another type of algorithm, such as an algorithm that generates pixel values based on the minimization of an error metric that represents a difference between a simulated high resolution image and a desired high resolution image 28. Such algorithms are described in the U.S. patent applications cited above, which are incorporated by reference.

### II. Nearest Neighbor

FIG. 5 is a diagram illustrating the generation of low resolution sub-frames 30A and 30B (collectively referred to as sub-frames 30) from an original high resolution image 28 using a nearest neighbor algorithm according to one embodiment of the present invention. In the illustrated embodiment, high resolution image 28 includes four columns and four rows of pixels, for a total of sixteen pixels H1-H16. In one embodiment of the nearest neighbor algorithm, a first sub-frame 30A is generated by taking every other pixel in a first row of the high resolution image 28, skipping the second row of the high resolution image 28, taking every other pixel in the third row of the high resolution image 28, and repeating this process throughout the high resolution image 28. Thus, as shown in FIG. 5, the first row of sub-frame 30A includes pixels H1 and H3, and the second row of sub-frame 30A includes pixels H9 and H11. In one form of the invention, a second sub-frame 30B is generated in the same manner as the first sub-frame 30A, but the process begins at a pixel H6 that is shifted down one row and over one column from the first pixel H1. Thus, as shown in FIG. 5, the first row of sub-frame 30B includes pixels H6 and H8, and the second row of sub-frame 30B includes pixels H14 and H16.

In one embodiment, the nearest neighbor algorithm is implemented with a 2×2 filter with three filter coefficients of “0” and a fourth filter coefficient of “1” to generate a weighted sum of the pixel values from the high resolution image. The nearest neighbor algorithm is also applicable to four-position processing, and is not limited to images having the number of pixels shown in FIG. 5. In one embodiment, the sub-frame pixel values calculated with the nearest neighbor algorithm represent boundary pixel values that are used by sub-frame generation unit 36 to generate actual pixel values for the sub-frames 30, as described in further detail below with reference to FIGS. 7-9.

### III. Bilinear

FIG. 6 is a diagram illustrating the generation of low resolution sub-frames 30C and 30D (collectively referred to as sub-frames 30) from an original high resolution image 28 using a bilinear algorithm according to one embodiment of the present invention. In the illustrated embodiment, high resolution image 28 includes four columns and four rows of pixels, for a total of sixteen pixels H1-H16. Sub-frame 30C includes two columns and two rows of pixels, for a total of four pixels L1-L4. And sub-frame 30D includes two columns and two rows of pixels, for a total of four pixels L5-L8.

In one embodiment, the values for pixels L1-L8 in sub-frames 30C and 30D are generated from the pixel values H1-H16 of image 28 based on the following Equations I-VIII:

L1=(4H1+2H2+2H5)/8 Equation I

L2=(4H3+2H4+2H7)/8 Equation II

L3=(4H9+2H10+2H13)/8 Equation III

L4=(4H11+2H12+2H15)/8 Equation IV

L5=(4H6+2H2+2H5)/8 Equation V

L6=(4H8+2H4+2H7)/8 Equation VI

L7=(4H14+2H10+2H13)/8 Equation VII

L8=(4H16+2H12+2H15)/8 Equation VIII

As can be seen from the above Equations I-VIII, the values of the pixels L1-L4 in sub-frame 30C are influenced the most by the values of pixels H1, H3, H9, and H11, respectively, due to the multiplication by four. But the values for the pixels L1-L4 in sub-frame 30C are also influenced by the values of diagonal neighbors of pixels H1, H3, H9, and H11. Similarly, the values of the pixels L5-L8 in sub-frame 30D are influenced the most by the values of pixels H6, H8, H14, and H16, respectively, due to the multiplication by four. But the values for the pixels L5-L8 in sub-frame 30D are also influenced by the values of diagonal neighbors of pixels H6, H8, H14, and H16.

In one embodiment, the bilinear algorithm is implemented with a 2×2 filter with one filter coefficient of “0” and three filter coefficients having a non-zero value (e.g., 4, 2, and 2) to generate a weighted sum of the pixel values from the high resolution image. In another embodiment, other values are used for the filter coefficients. The bilinear algorithm is also applicable to four-position processing, and is not limited to images having the number of pixels shown in FIG. 6. In one embodiment, the sub-frame pixel values calculated with the bilinear algorithm represent boundary pixel values that are used by sub-frame generation unit 36 to generate actual pixel values for the sub-frames 30, as described in further detail below with reference to FIGS. 7-9.

In one form of the nearest neighbor and bilinear algorithms, boundary pixel values for sub-frames 30 are generated based on a linear combination of pixel values from an original high resolution image 28 as described above. In another embodiment, boundary pixel values for sub-frames 30 are generated based on a non-linear combination of pixel values from an original high resolution image 28. For example, if the original high resolution image 28 is gamma-corrected, appropriate non-linear combinations are used in one embodiment to undo the effect of the gamma curve.

### IV. Generation of Actual Pixel Values Based on Boundary Pixel Values

FIG. 7 is a diagram illustrating the generation of actual pixel values for sub-frames 30 based on previously calculated boundary pixel values according to one embodiment of the present invention. As shown in FIG. 7, high-resolution image 28 includes four pixels 702 with pixel values represented by letters A, B, C, and D. In one embodiment, high-resolution image 28 includes more than four pixels 702, but only four pixels 702 are shown in FIG. 7 to simplify the illustration and explanation. In one embodiment, high-resolution image 28 is displayed by display system 100 using four spatially shifted sub-frames 30 and four-position processing (see, e.g., FIGS. 3A-3E and corresponding description) to produce displayed image 14.

In the embodiment shown in FIG. 7, displayed image 14 includes four pixels with positions identified by pixel centers 704A-704D. In one embodiment, the pixel boundaries of the pixels corresponding to pixel centers 704A-704D overlap, such as shown in FIGS. 4A-4E, but the pixel boundaries are not shown in FIG. 7 to simplify the illustration. FIG. 7 also shows an X-axis 706 and a Y-axis 708. Pixel center 704A is positioned at (x=0, y=0), and corresponds to a pixel of a first sub-frame 30. Pixel center 704B is positioned at (x=1, y=0), and corresponds to a pixel of a second sub-frame 30. Pixel center 704C is positioned at (x=0, y=1), and corresponds to a pixel of a third sub-frame 30. Pixel center 704D is positioned at (x=1, y=1), and corresponds to a pixel of a fourth sub-frame 30. In the illustrated embodiment, the pixel centers 704A-704D of the four sub-frames 30 are shifted in a counterclockwise manner as represented by arrows 710.

The pixels corresponding to pixel centers 704A-704D have pixel values represented by letters A′, B′, C′, and D′, respectively. In one form of the invention, the pixel values A′, B′, C′, and D′ are each a function of the pixel values A, B, C, and D of high-resolution image 28, as shown by the following Equations IX-XII:

A′=f(A,B,C,D) Equation IX

B′=f(A,B,C,D) Equation X

C′=f(A,B,C,D) Equation XI

D′=f(A,B,C,D) Equation XII

Pixel values A′, B′, C′, and D′ are calculated using the nearest neighbor algorithm (FIG. 5), bilinear algorithm (FIG. 6), or other suitable algorithm. In the illustrated embodiment, the pixel values A′, B′, C′, and D′ are boundary pixel values, and are used by sub-frame generation unit 36 to calculate pixel values for pixels at any position within the rectangular boundary defined by pixel centers 704A-704D (i.e., within the rectangular boundary formed by arrows 710). For example, FIG. 7 shows a pixel center 712 within the boundary defined by pixel centers 704A-704D, which has a pixel value represented by P″. In one form of the invention, the pixel value P″ for a pixel at any location within the boundary defined by pixel centers 704A-704D is calculated by linear interpolation or weighting, such as shown in the following Equation XIII:

P″=A′(1−x)(1−y)+B′(x)(1−y)+C′(1−x)(y)+D′(x)(y) Equation XIII
Where:
   x=position of the pixel center 712 along the x-axis 706; and
   y=position of the pixel center 712 along the y-axis 708.

In this embodiment, the displayed pixel having pixel center 712 has a pixel value P″ that is equal to a weighted sum of pixel values from four sub-frames 30 in a four-position processing configuration. The weighted sum can be calculated for P″ anywhere within the (x,y) boundary defined by the four pixel centers 704A-704D using Equation XIII. In another form of the invention, the pixel value P″ for a pixel at any location within the boundary defined by pixel centers 704A-704D is calculated by non-linear interpolation or weighting.

If two position processing were used for the boundary pixel values rather than four position processing (e.g., using two positions, such as those corresponding to pixel centers 704A and 704B), the pixel values A′ and B′ would be the boundary pixel values in this embodiment, and would be used by sub-frame generation unit 36 to calculate pixel values for pixels at any position on a line extending between pixel centers 704A and 704B.

In one embodiment, sub-frame generation unit 36 is configured to generate pixel values for sub-frames 30 for two-position or four-position processing, and then use these pixel values as boundary pixel values to generate actual pixel values (e.g., using Equation XIII) for any desired sub-frame motion, including triangular motion (represented by arrows 714 in FIG. 7), circular motion (represented by arrows 716 in FIG. 7), or any other desired motion or pattern. In one form of the invention, the sub-frames 30 are displayed at discrete locations along the desired path, and the sub-frame pixel values are calculated for each of the discrete locations using Equation XIII. In another form of the invention, the sub-frames 30 are shifted continuously or substantially continuously along the desired path, and the sub-frame pixel values are calculated continuously using Equation XIII. The calculation of weighted sums of boundary pixel values as described above provides a generalized solution for determining sub-frame pixel values for any arbitrary set of discrete or continuous-space shifts between sub-frames 30, including circular shifts as shown in FIG. 8 and described below.

FIG. 8 is a diagram illustrating a plurality of sub-frames 30 shifted along a circle 802 according to one embodiment of the present invention. As shown in FIG. 8, sub-frame 30E is displayed at sub-frame position 810A on circle 802, sub-frame 30F is displayed at sub-frame position 810B on circle 802, and sub-frame 30G is displayed at sub-frame position 810C on circle 802. In one form of the invention, sub-frames 30 are displayed at continuous shifts along the circle 802. In another form of the invention, sub-frames 30 are displayed at discrete shifts along the circle 802. Three sub-frames 30 are shown in FIG. 8 to illustrate circular processing according to one form of the invention. It will be understood by persons of ordinary skill that any desired number of sub-frames 30 may be displayed along circle 802.

In one embodiment, display device 26 (FIG. 1) displays multiple sub-frames 30, such as sub-frames 30E, 30F, and 30G, in a temporally and spatially shifted manner along a circle 802 to produce displayed image 14, which can appear to have a higher resolution than the individual sub-frames 30. In one embodiment, display device 26 performs multiple iterations of displaying a set of sub-frames 30 along the circle 802 (i.e., multiple trips are made around the complete circle 802). In one embodiment, the set of sub-frames 30 displayed during a given iteration correspond to one image frame 28. Thus, in one form of the invention, a first set of sub-frames 30 corresponding to a first image frame 28 are displayed along the circle 802 to produce a first displayed image 14, a second set of sub-frames 30 corresponding to a second image frame 28 are displayed along the circle 802 to produce a second displayed image 14, etc.

In one embodiment, the pixel values for the sub-frames 30 displayed along the circle 802 are generated by first calculating boundary pixel values based on fixed four-position processing, and then using linear or non-linear weighting of the boundary pixel values, as described above with respect to FIG. 7, to generate the actual pixel values that are used for the displayed sub-frames 30.

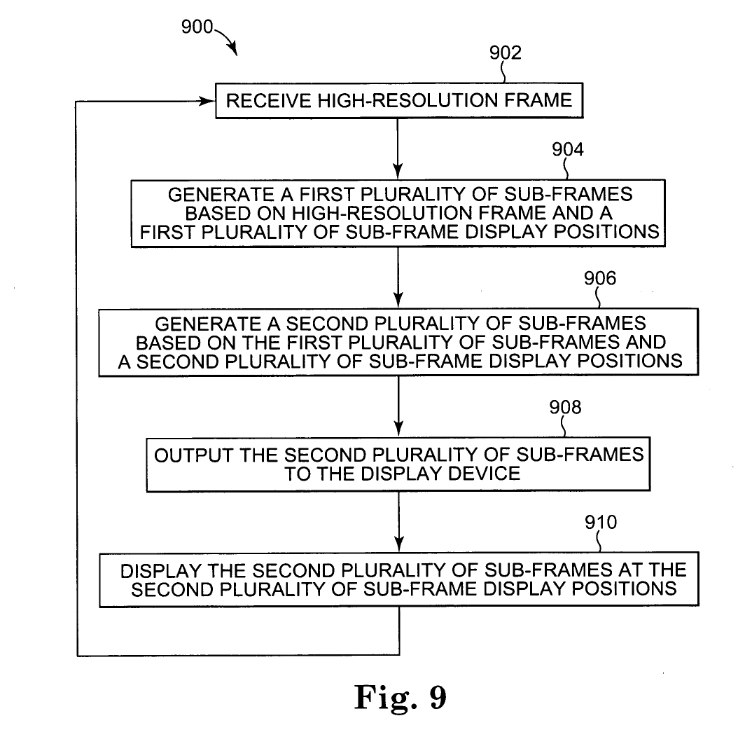

FIG. 9 is a flow diagram illustrating a method 900 for generating actual pixel values for sub-frames 30 based on previously calculated boundary pixel values according to one embodiment of the present invention. At 902, sub-frame generation unit 36 (FIG. 1) receives a high-resolution image frame 28. At 904, sub-frame generation unit 36 generates a first plurality of sub-frames 30 corresponding to the received image frame 28 based on a first plurality of spatially offset sub-frame display positions using a nearest neighbor algorithm, bilinear algorithm, or other suitable sub-frame generation algorithm. In one embodiment, sub-frame generation unit 36 generates two sub-frames 30 at 904 based on two-position processing for two spatially offset sub-frame display positions. In another embodiment, sub-frame generation unit 36 generates four sub-frames 30 at 904 based on four-position processing for four spatially offset sub-frame display positions. The sub-frames generated at 904 provide boundary pixel values for use in generating actual pixel values for display.

At 906, sub-frame generation unit 36 generates a second plurality of sub-frames 30 based on the first plurality of sub-frames 30 generated at 904, and based on a second plurality of spatially offset sub-frame display positions. In one embodiment, at 906, sub-frame generation unit 36 generates the second plurality of sub-frames 30 based on a linear weighting of the pixel values in the first plurality of sub-frames 30, such as described above with respect to FIG. 7. In another embodiment, at 906, sub-frame generation unit 36 generates the second plurality of sub-frames 30 based on a non-linear weighting of the pixel values in the first plurality of sub-frames 30. In one form of the invention, the second plurality of sub-frame display positions at 906 lies on a circle. In other forms of the invention, the second plurality of sub-frame display positions at 906 lies on a triangle, or any other desired shape. In one embodiment, the second plurality of sub-frame display positions are completely different than the first plurality of sub-frame display positions. In another embodiment, the second plurality of sub-frame display positions includes one or more of the same positions as the first plurality of sub-frame display positions, and also includes additional sub-frame display positions that are not part of the first plurality of sub-frame display positions.

At 908, sub-frame generation unit 36 outputs the second plurality of sub-frames 30 (generated at 906) to display device 26. At 910, display device 26 displays the second plurality of sub-frames 30 at the second plurality of sub-frame display positions. The method 900 then returns to 902 to receive and process the next high-resolution image frame 28.

One form of the present invention provides a method for calculating sub-frames for any arbitrary sub-frame display positions or patterns, including circular patterns. In addition, embodiments of the present invention can also be used to solve other problems that can occur in display systems. For example, if the display or movement mechanism is imprecise and pixels are not being displayed in the desired positions, such as lens distortion issues that cause the movement distances at the corners to be different than the movement distances at the centers of sub-frames 30, or if the pixel positions drift from the desired positions over time, one embodiment of the present invention is used to calculate pixel values for the desired positions, and then calculating a weighted sum of these values based on the actual pixel positions to compensate for the difference in positions. Also, if there is no specific dwell position for pixels, such as in one embodiment of circular processing where sub-frames 30 are continuously moved around a circle, one form of the present invention is used to calculate pixel values for the continuously moving sub-frames 30 based on a weighted sum of pixel values of a plurality of sub-frames at a plurality of fixed positions. In addition, if the mechanism movement is not as desired, one form of the present invention employs a contour map over the entire image region to provide pixel-by-pixel compensation.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of displaying an image with a display device, the method comprising:
receiving image data for the image;
generating a first plurality of sub-frames corresponding to the image data based on a first plurality of spatially offset sub-frame positions;
generating a second plurality of sub-frames based on the first plurality of sub-frames and based on a second plurality of spatially offset sub-frame positions; and
displaying the second plurality of sub-frames at the second plurality of spatially offset sub-frame positions.

2. The method of claim 1, wherein pixel values for the second plurality of sub-frames are generated based on a weighted sum of pixel values of the first plurality of sub-frames.

3. The method of claim 1, wherein pixel values for the second plurality of sub-frames are generated based on a linear interpolation of pixel values of the first plurality of sub-frames.

4. The method of claim 1, wherein pixel values for the second plurality of sub-frames are generated based on a non-linear interpolation of pixel values of the first plurality of sub-frames.

5. The method of claim 1, wherein the first plurality of sub-frame positions includes two positions that define a boundary, and wherein the second plurality of sub-frame positions lie on or within the boundary.

6. The method of claim 1, wherein the first plurality of sub-frame positions includes four positions that define a boundary, and wherein the second plurality of sub-frame positions lie on or within the boundary.

7. The method of claim 1, wherein the second plurality of sub-frame positions is located on a circle.

8. The method of claim 1, wherein the second plurality of sub-frame positions forms a substantially continuous pattern.

9. A system for displaying an image, the system comprising:
a buffer adapted to receive image data for an image;
an image processing unit configured to define a first set of sub-frames corresponding to the image data, the first set of sub-frames defined based on a first set of spatially offset sub-frame positions, the image processing unit configured to define a second set of sub-frames based on the first set of sub-frames and based on a second set of spatially offset sub-frame positions that is different than the first set of sub-frame positions; and
a display device adapted to display the second set of sub-frames at the second set of spatially offset sub-frame positions.

10. The system of claim 9, wherein pixel values for the second set of sub-frames are calculated based on a weighting of pixel values of the first set of sub-frames.

11. The system of claim 9, wherein pixel values for the second set of sub-frames are calculated based on a linear weighting of pixel values of the first set of sub-frames.

12. The system of claim 9, wherein pixel values for the second set of sub-frames are calculated based on a non-linear weighting of pixel values of the first set of sub-frames.

13. The system of claim 9, wherein the first set of sub-frame positions includes two positions that define a line, and wherein the second set of sub-frame positions lie on the line.

14. The system of claim 9, wherein the first set of sub-frame positions includes four positions that define a rectangular boundary, and wherein the second set of sub-frame positions lie on or within the rectangular boundary.

15. The system of claim 9, wherein the second set of sub-frame positions is located on a circle.

16. The system of claim 9, wherein the second set of sub-frame positions forms a substantially continuous pattern.

17. A method of generating low resolution sub-frames for display at spatially offset positions to generate the appearance of a high resolution image, the method comprising:
receiving a high resolution image;
generating a first plurality of pixel values for a first plurality of low resolution sub-frames based on the high resolution image and a first set of spatially offset sub-frame positions; and
generating a second plurality of pixel values for a second plurality of low resolution sub-frames based on a weighted sum of pixel values in the first plurality of pixel values.

18. The method of claim 17, wherein the second plurality of pixel values are generated based on a second set of spatially offset sub-frame positions.

19. The method of claim 17, wherein the second plurality of pixel values is generated based on a linear weighting of pixel values in the first plurality of pixel values.

20. The method of claim 17, wherein the second plurality of pixel values is generated based on a non-linear weighting of pixel values in the first plurality of pixel values.
